(19) United States
(12) Patent Application Publication
(10) Pub. No.: US 2008/0254258 A1
(43) Pub. Date: Oct. 16, 2008

(54) TEFLON® REPLACEMENTS AND RELATED PRODUCTION METHODS

(75) Inventor: Michael MOLNAR, Greensboro, NC (US)

Correspondence Address: MORRISON & FOERSTER LLP, 425 MARKET STREET, SAN FRANCISCO, CA, 94105-2482, US

(73) Assignee: ALTAIRNANO, INC., Reno, NV (US)

(21) Appl. No.: 12/101,075

(22) Filed: Apr. 10, 2008

Related U.S. Application Data
(60) Provisional application No. 60/911,477, filed on Apr. 12, 2007.

(51) Int. Cl. D06N 7/04; B05D 1/12; H05H 1/26; C25F 3/16; B44C 1/22

(52) U.S. Cl. 428/148; 427/180; 427/446; 205/640; 216/52

(57) ABSTRACT

The methods and compositions described herein generally relate to methods and compositions for providing a non-stick surface on selected materials. In a method aspect, the methods and compositions described herein provide a method of making a non-stick surface on a metal substrate. The method includes the following steps: a) applying nanostructured zirconia or nanostructured titania to a metal substrate; and b) polishing the surface of the metal substrate.

### CROSS REFERENCE TO RELATED APPLICATION

This application claims priority to U.S. Provisional Patent Application Ser. No. 60/911,477 filed on Apr. 12, 2007, which is incorporated herein by reference in its entirety for all purposes.

### FIELD

The methods and compositions described herein generally relate to methods and compositions for providing a non-stick surface on selected materials.

### BACKGROUND

The Environmental Protection Agency (EPA) has instituted a Global Stewardship Program to reduce perfluorooctanoic acid (PFOA) in the environment. To date, eight large chemical companies have committed to the voluntary program: Arkema, Asahi, Ciba, Clariant, Daikin, DuPont, 3M/Dyneon, and Solvay Solexis. This represents 100 percent participation according to EPA objectives.

According to the Global Stewardship Program, participating companies must reduce PFOA emissions and PFOA levels in products by 95 percent no later than 2010. The companies must further work toward eliminating sources of PFOA exposure five years after that, but no later than 2015. Companies are being asked to meet these commitments in the United States as well as in their global operations. See EPA report entitled “100 Percent Participation and Commitment in EPA's PFOA Stewardship Program,” released Mar. 2, 2006.

PFOA is used in the production of TEFLON®. This necessarily means that phasing out PFOA under the stewardship program results in the phasing out of TEFLON® within the same time period. The non-stick products consumers have come to depend on must accordingly be made through different methods; the non-stick portion of products must be replaced by a different composition.

There is little information currently available with respect to TEFLON® replacements. One company, Popper & Sons, is marketing a replacement coating, PSX-H, for use on needles that have laboratory applications. See www.popperandsons.com.

Accordingly, there is a need in the art for new methods and compositions that will produce and serve as TEFLON® replacements. That is one object of the methods and compositions described herein.

### SUMMARY

The methods and compositions described herein generally relate to methods and compositions for providing a non-stick surface on selected materials.

In a method aspect, the methods and compositions described herein provide a method of making a non-stick surface on a metal substrate. The method includes the steps of: a) applying nanostructured zirconia or nanostructured titania to a metal substrate; and b) polishing the surface of the metal substrate.

In a product-by-process aspect, the methods and compositions described herein provide a metal substrate having a non-stick surface. The surface is made using a method that includes the following steps: a) applying nanostructured zirconia or nanostructured titania to a metal substrate; and b) polishing the surface of the metal substrate.

### DETAILED DESCRIPTION

In order to provide a more thorough understanding of the compositions and methods described herein, the following description sets forth numerous specific details, such as methods, parameters, examples, and the like. It should be recognized, however, that such description is not intended as a limitation on the scope of the compositions and methods described herein, but rather is intended to provide a better understanding of the possible variations.

The methods and compositions described herein generally relate to processes and compositions for providing a non-stick surface on selected materials.

The methods and compositions described herein provide non-stick surfaces on a variety of metal materials or products. Non-limiting examples of materials or products containing such non-stick surfaces include: metal based cookware and consumer goods; vehicles and vehicle parts containing metal surfaces, such as motorcycles, bicycles, automobiles, snow vehicles, ships, airplanes, helicopters, etc.; building materials; furniture; electronic goods; toys; industrial tools, robotic devices; heavy machinery; motors; and engines.

These surfaces provided by the methods and compositions described herein may be used in military vehicles as anti-corrosion and anti-wear coatings in harsh environments which may include hot, dry, and sandy environments. Such military vehicles may include aircraft, light tanks, main battle tanks, armored personnel carriers (APCs), infantry fighting vehicles (IFVs), armored scout vehicles, armored cars, light armored vehicles, dedicated anti-armor vehicles, specialist armored vehicles, self-propelled gun and artillery vehicles, self-propelled anti-aircraft artillery vehicles, amphibious vehicles, prime movers, and trucks.

The surfaces provided by the methods and compositions described herein may also be used in maritime vehicles and vessels which may decrease the sound signature of the vessels. Such vehicles and vessels may include aircraft carriers, amphibious vehicles, barges, container ships, cargo ships, cruisers, cutters, destroyers, combat ships, minesweepers, motorboats, steamships, submarine chasers, submarine tenders, submarines, torpedoes, torpedo boats, transports, dispatch boats, supply vehicles, supertankers, steamboats, hovercrafts, hydrofoils, jetfoils, yachts, frigates, and tankers.

In some variations, the surfaces provided by the methods and compositions described herein comprise nanostructured zirconia and/or nanostructured titania primary particles that are agglomerated as micron-sized powders. The powders may be applied to material surfaces using a variety of suitable techniques. Non-limiting examples of such techniques are conventional combustion, plasma, high velocity oxy fuel (HVOF), and more recently developed cold thermal spraying processes. The micron-sized agglomerated powders may vary in size; the variance depends on the type of spraying equipment used and the application parameters. The nanosized primary particles densely pack to provide a hard coating, which may be polished to afford a non-stick surface using skills known to one of ordinary skill in the art.

Nanostructured zirconia and titania primary particles have linear dimensions on the order of nanometers (10⁻⁹ m). In some variations, the linear dimensions are in the range from about 1 nm to about 100 nm. “Nanostructured” materials may also be referred to as “ultrafine” or “nano-sized”. “Zirconia” and “titania” may also be referred to as “zirconium oxide” and “titanium oxide”; “zirconium dioxide” and “titanium dioxide”; or “ZrO₂” and “TiO₂.”

Conventional zirconia (ZrO₂) exhibits toughness, wear resistance, hardness, and other properties that make it useful in numerous industrial applications. Stabilized zirconia (stabilized, for example, by rare earth or alkali earth metal compounds) exhibits high fracture toughness, absorbs energy of impact that shatters other ceramics, and can tolerate thermal gradients better than most other materials. Nanostructured zirconia and nanostructured stabilized zirconia exhibit favorable properties over the conventional form, including significant reduction in sintering temperature, ability to deform superplastically under applied stress, higher diffusivities, and higher ionic conductivities. These improved properties are exploited in the manufacture of solid oxide fuel cells and spray coatings with superior mechanical attributes.

Three commonly occurring crystal forms of zirconia are cubic, tetragonal, and monoclinic. The cubic form is the high temperature form and is stable above 2370° C. The tetragonal form is stable between 1170° C. and 2370° C. The monoclinic form is stable below 1170° C. The monoclinic to tetragonal phase change is accompanied by a volume change of about 4%. Cooling from the manufacturing temperature often destroys pure zirconia, or gives it inferior mechanical properties. Therefore, it is often desirable to stabilize the zirconia in some fashion.

Existing methods to produce nanostructured zirconia powders include co-precipitation using zirconium alkoxides, sol-gel synthesis, spray drying, and freeze-drying. Existing gas-phase methods include inert gas condensation and chemical vapor deposition. These methods are not economical to produce bulk quantities of nanostructured zirconia. Recently, simpler and less expensive aqueous chemical methods have been developed to produce nanostructured zirconia. U.S. Pat. No. 6,162,530 and U.S. Pat. No. 6,517,802 disclose a process to make nanostructured zirconia from aqueous solutions by atomizing an aqueous solution of the desired metals in a stream of nitrogen and contacting the resulting particles with a spray of recirculating aqueous solution at controlled pH. Further treatment includes sequential heat treatment, ultrasonication, and spray drying. U.S. Pat. No. 6,982,073 describes a process for the manufacture of nanostructured stabilized zirconia that comprises preparing an aqueous feed solution that contains a zirconium salt and a stabilizing agent, converting the feed solution under controlled evaporation conditions to form an intermediate, and calcining the intermediate to form agglomerates of nanostructured particles. Subsequent milling and/or further spray drying may be used to produce agglomerates of nanostructured particles in the desired size range.

Conventional titania (TiO₂) is used widely in pigments, paints, paper, plastics, ceramics, and inks. Titania exists in three different crystalline structures: rutile, anatase, and brookite. Rutile and anatase both exist in tetragonal form; brookite exists in orthorhombic form. Rutile is the most thermodynamically stable, whereas anatase is metastable. The titania used in pigments generally has an average primary particle size of 150 to 250 nanometers, a high refractive index, and negligible color, and is inert. Nanostructured titania has a lower average primary particle size from about 1 to about 100 nanometers and is used commercially in cosmetics and personal care products, plastics, surface coatings, self-cleaning surfaces, and photovoltaic applications.

Nanostructured titania is synthesized by a variety of methods, some in commercial use and some in development. In one variation, anhydrous titanium tetrachloride is used as a feedstock and is burned in an oxygen-hydrogen flame or in a plasma arc. Another process uses a titanyl sulfate solution as the feedstock from which titanium dioxide is precipitated in a controlled manner followed by calcination and steam micronization to break up agglomerates formed during the calcination step. Both types of process suffer from a lack of control over the product size distribution, as well product structure. For example, the titanyl sulfate process produces the anatase form, whereas the anhydrous chloride oxidation produces the rutile form. A newer process reported in U.S. Pat. No. 6,440,383 produces nanostructured titania from titanium containing solutions, particularly titanium chloride solutions. The process is conducted by total evaporation of the solution above the boiling point of the solution and below the temperature where there is significant crystal growth. Chemical control additives may be added to control particle size. These additives may include: the halide, carbonate, sulfate, and phosphate salts of sodium, potassium, aluminum, tin, zinc, and other metals. Organic control additives may include organic acids such as oxalic, citric, and stearic acids; salts of organic acids; polyacrylates; glycols; siloxanes; and other compounds. After the evaporation step, calcination is carried out to produce nanostructured titania particles. The chemical control agents may be added to the amorphous oxide just prior to calcination to promote and control conversion of the oxide to the desired crystal structure and other physical characteristics such as crystal size and millability. The nanostructured titania produced may be either anatase or rutile depending on the concentration of the synthesis, the type of chemical control additive, and calcination conditions. Following calcination, the nanostructured titania is milled or dispersed to yield a final product having a narrow particle size distribution.

In some variations, once the nanostructured powders are obtained, the powders may be applied to material surfaces using a variety of suitable techniques well-known in the art. Examples of such techniques include plasma spraying, combustion flame spraying, high velocity oxy fuel spraying (HVOF), or newer cold thermal spraying processes. Plasma spraying, combustion flame spraying, and high velocity oxy fuel spraying (HVOF) processes are described in, for example, U.S. Pub. No. 20070116809 and U.S. Pat. No. 6,455,108; U.S. Pat. No. 6,861,101; and U.S. Pat. No. 7,163,715. Cold thermal spraying processes are described in, for example, U.S. Pat. No. 6,861,101; U.S. Pat. No. 7,163,715; and WO 04/080918. Most thermal spraying processes comprise heating a material in powder, wire or rod form near or somewhat above its melting point and accelerating the droplets in a gas stream. The droplets are directed against the surface of a substrate to be coated where they adhere and flow into thin lamellar particles called splats.

In the plasma spray coating process, a gas is partially ionized by an electric arc as it flows around a tungsten cathode and through a relatively short nozzle. The temperature of the plasma at its core may exceed 30,000 K, and the velocity of the gas may be supersonic. Coating material, usually in the form of powder, is injected into the gas plasma and is heated to near or above its melting point and accelerated to a velocity that may reach about 600 m/sec. The rate of heat transfer to the coating material and the ultimate temperature of the coating material are a function of the flow rate and composition of the gas plasma as well as the torch design and powder injection technique. The molten particles are projected against the surface to be coated forming adherent splats.

In the combustion flame spraying process, oxygen and a fuel such as hydrogen, propane, propylene, acetylene, or kerosene are combusted in a torch. Powder, wire, or rod is injected into the flame where it is melted and accelerated. Particle velocities may reach about 300 m/sec. In some variations of powder flame spraying, a small amount of oxygen from the gas supply is diverted to carry the powdered active material by aspiration into the oxygen-fuel gas flame where the powder is heated and propelled by the exhaust flame onto the substrate to be coated. The maximum temperature of the gas and ultimately the coating material is a function of the flow rate and composition of the gases used and the torch design. The molten particles are projected against the surface to be coated forming adherent splats.

In the high velocity oxy fuel (HVOF) spraying process, oxygen, air or another source of oxygen is used to burn a fuel such as hydrogen, propane, propylene, acetylene, or kerosene, in a combustion chamber and the gaseous combustion products are allowed to expand through a nozzle. The gas velocity may be supersonic. Powdered coating material is injected into the nozzle and heated to near or above its melting point and accelerated to a relatively high velocity, such as up to about 600 m/sec. The powder may be fed axially into the combustion chamber under high pressure or fed through the side of a de Laval type nozzle, where the pressure is lower. The temperature and velocity of the gas stream through the nozzle, and ultimately the powder particles, may be controlled by varying the composition and flow rate of the gases or liquids into the gun. The spray may be controlled such that the temperature of the particles being propelled is a temperature sufficient to soften the particles such that they adhere to the surface and less than a temperature that causes decomposition of the coating materials. The molten particles impinge on the surface to be coated and flow into fairly densely packed splats that are well bonded to the substrate and/or each other. Typically these coatings are denser than those produced by combustion powder flame spraying.

In other variations, a cold thermal spraying process may be used. Generally, the powder particles may not be sprayed in a molten or semi-molten state as in the other thermal spray process, but may be sprayed as powder particles at high velocities (300-1500 m/sec). In one variation, the powder particles may be fed with a cold, high pressure carrier gas which is converged coaxially into a plasma flame. The effluent forms a gas stream with a net temperature, based on the enthalpy of the plasma stream and the temperature and volume of the cold high pressure converging gas, such that the powdered material will not melt. The combined flow may be directed through a nozzle accelerating the flow to velocities that allow the particles to strike the target surface to achieve kinetic energy transformation into elastic deformation of the particles as they impact the surface forming a cohesive coating. In another variation, the target surface may be heated to the desired temperature until the surface is melted or partially melted. Cold particles may then be sprayed directly onto the melted or partially melted surface.

Once the nanostructured powders are deposited onto the target surface, the surface may be polished to afford a non-stick surface using skills known to one of ordinary skill in the art. Polishing or mechanical polishing, typically comprises applying abrasives which may be coated, non-woven, and/or woven to the surface to be polished. Abrasives may include aluminum oxide, cerium oxide, zirconium oxide, tin oxide, silicon dioxide, silicon carbide, titanium dioxide, and titanium carbide. An apparatus may be used to apply the abrasives and smooth the surface. Such methods are described, for example, in U.S. Pat. No. 4,358,295 and U.S. Pat. No. 4,959,113.

Another polishing method which may be employed is chemical-mechanical planarization or chemical-mechanical polishing, commonly abbreviated CMP. In this process, the substrate is placed in direct contact with a rotating polishing pad. A carrier applies pressure against the substrate. During the polishing process, the pad and substrate holder are rotated while a downward force is maintained against the substrate. An abrasive and chemically reactive solution, commonly referred to as a “slurry” may be deposited onto the pad during polishing. The slurry may initiate the polishing process by chemically reacting with the film being polished. The process is facilitated by the rotational movement of the pad relative to the substrate as slurry is provided to the surface/pad interface. Slurries typically contain an abrasive material, such as silica or alumina, suspended in an oxidizing aqueous solution which may include potassium or ammonium hydroxide, hydrogen peroxide, perchloric acid, or potassium ferricyanide. Such methods are described in U.S. Pat. No. 5,209,816; U.S. Pat. No. 5,244,534; U.S. Pat. No. 5,340,370; U.S. Pat. No. 5,958,288; and U.S. Pat. No. 6,001,730.

Another variation of polishing is electropolishing. Electropolishing comprises passing an electrical current through the substrate to be polished. The substrate is typically submerged into a conductive vessel containing an electrolyte. A voltage difference is then applied across the workpiece and the vessel, acting as anode and cathode respectively. The resulting current flow within the electrolyte between anode and cathode causes dissolution of the anodic surface and a corresponding deposit on the cathodic surface. Descriptions of electropolishing may be found in U.S. Pat. No. 6,416,650 and U.S. Pat. No. 6,599,415.

The non-stick nature of a material or product produced according to the methods and compositions described herein may be defined by the relative coefficient of friction (COF) between one surface composed of a given material and another surface of a second material. The COF of a material may be determined using different ASTM test methods using pull-meters such as: ASTM F609-1996; ASTM F802; and ASTM E303. The COF for hard steel on hard steel on a flat dry surface is 0.78 and hard steel on greased hard steel is 0.1. The COF of hard steel on dry or greased Teflon® is 0.04. The COF of hard steel on a material surface produced according to the methods and compositions described herein is typically less than 0.4. In some variations, the COF is less than 0.2. In some variations, the COF is less than 0.15 or 0.10. In some variations, the COF is less than 0.08 or 0.06.

In some variations, the methods described herein include method of making a non-stick surface on a metal substrate by applying at least one of nanostructured titania powder particles or nanostructured zirconia powder particles to a metal substrate, and polishing the surface of the metal substrate to provide a non-stick surface on the metal substrate. In some variations, the applying step comprises of applying nanostructured titania powder particles and nanostructured zirconia powder particles. In some variations, the applying step is one of the following: plasma spraying, combustion flame spraying, high velocity oxy fuel spraying (HVOF), and/or cold thermal spraying. In some variations, the polishing step is one of the following: mechanical polishing, chemical-mechanical polishing, and/or electropolishing. In some variations, the polishing step is mechanical polishing. In some variations, the powder particles are from about 1 to about 100 microns in size. In some variations, the powder particles are from about 15 to about 50 microns in size. In some variations, the powder particles are from about 5 to about 20 microns in size. In some variations, the applying step comprises high velocity oxy fuel spraying. In some variations, the relative coefficient of friction between the non-stick surface and hard steel is from about 0.06 to about 0.4. In some variations, the relative coefficient of friction between the non-stick surface and hard steel is less than about 0.2. In some variations, the relative coefficient of friction between the non-stick surface and hard steel is less than about 0.1. In some variations, the relative coefficient of friction between the non-stick surface and hard steel is less than about 0.08.

In some variations, the powder particles are from about 15 to about 50 microns in size; the applying step comprises combustion flame spraying; the polishing step comprises mechanical polishing; and the relative coefficient of friction between the non-stick surface and hard steel is less than about 0.1.

In some variations, the powder particles are from about 5 to about 20 microns in size; the applying step comprises high velocity oxy fuel spraying; the polishing step comprises mechanical polishing; and the relative coefficient of friction between the non-stick surface and hard steel is less than about 0.1.

In some variations, the nanostructured zirconia powder particles are nanostructured stabilized zirconia powder particles. In some variations, the nanostructured stabilized zirconia powder particles are stabilized with alkali earth compounds, rare earth compounds, or combinations thereof.

In some variations, the compositions described herein comprise a non-stick surface on a metal substrate, where the non-stick surface comprises least one of nanostructured zirconia or nanostructured titania, and where the relative coefficient of friction between the non-stick surface and hard steel is less than about 0.4. In some variations, the non-stick surface comprises nanostructured zirconia and nanostructured titania. In some variations, the non-stick surface comprises least one of nanostructured zirconia powder particles or nanostructured titania powder particles. In some variations, the non-stick surface comprises nanostructured zirconia powder particles and nanostructured titania powder particles. In some variations, the powder particles are from about 1 to about 100 microns in size. In some variations, the powder particles are from about 15 to about 50 microns in size. In some variations, the powder particles are from about 5 to about 20 microns in size. In some variations, the relative coefficient of friction between the non-stick surface and hard steel is from about 0.06 to about 0.4. In some variations, the relative coefficient of friction between the non-stick surface and hard steel is less than about 0.2. In some variations, the relative coefficient of friction between the non-stick surface and hard steel is less than about 0.1. In some variations, the relative coefficient of friction between the non-stick surface and hard steel is less than about 0.08.

### EXAMPLE 1

Nanostructured titania agglomerated to 5-20 micron-sized powders is applied to a steel substrate using high velocity oxy fuel (HVOF) spraying equipment. The deposited powder is allowed to cool to room temperature to produce a coating on the steel substrate. The coated surface of the steel substrate is mechanically polished to produce a non-stick, mirror-like surface.

### EXAMPLE 2

Nanostructured titania agglomerated to 15-50 micron-sized powders is applied to a steel substrate using combustion flame spraying equipment. The deposited powder is allowed to cool to room temperature to produce a coating on the steel substrate. The coated surface of the steel substrate is mechanically polished to produce a non-stick, mirror-like surface.

### EXAMPLE 3

Nanostructured zirconia or nanostructured stabilized zirconia agglomerated to 5-20 micron-sized powders is applied to a steel substrate using High Velocity Oxy Fuel (HVOF) thermal spray equipment. The deposited powder is allowed to cool to room temperature to produce a coating on the steel substrate. The coated surface of the steel substrate is mechanically polished to produce a non-stick, mirror-like surface.

### EXAMPLE 4

Nanostructured zirconia or nanostructured stabilized zirconia agglomerated to 15-50 micron-sized powders is applied to a steel substrate using combustion flame spraying equipment. The deposited powder is allowed to cool to room temperature to produce a coating on the steel substrate. The coated surface of the steel substrate is mechanically polished to produce a non-stick, mirror-like surface.

Although methods and compositions described herein have been described in connection with some variations, it is not intended to be limited to the specific form set forth herein. Rather, the scope of the methods and compositions described herein is limited only by the claims. Additionally, although a feature may appear to be described in connection with particular variations, one skilled in the art would recognize that various features of the described variations may be combined in accordance with the methods and compositions described herein.

Furthermore, although individually listed, a plurality of means, elements or method steps may be implemented by, for example, a single method. Additionally, although individual features may be included in different claims, these may be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Terms and phrases used in this document, and variations thereof, unless otherwise expressly stated, should be construed as open ended as opposed to limiting. As examples of the foregoing: the term “including” should be read to mean “including, without limitation” or the like; the terms “example” or “some variations” are used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the methods and compositions described herein may be described or claimed in the singular, the plural is contemplated to be within the scope thereof unless limitation to the singular is explicitly stated. The presence of broadening words and phrases such as “one or more,” “at least,” “but not limited to,” “in some variations” or other like phrases in some instances shall not be read to mean that the narrower case is intended or required in instances where such broadening phrases may be absent.

1. A method of making a non-stick surface on a metal substrate, comprising the steps of:
a) applying at least one of nanostructured titania powder particles or nanostructured zirconia powder particles to a surface of a metal substrate; and
b) polishing the surface of the metal substrate to provide a non-stick surface on the metal substrate.

2. The method of claim 1, wherein the applying step comprises applying nanostructured titania powder particles and nanostructured zirconia powder particles.

3. The method of claim 1, wherein the applying step is selected from the group consisting of plasma spraying, combustion flame spraying, high velocity oxy fuel spraying (HVOF), and cold thermal spraying.

4. The method of claim 1, wherein the polishing step is selected from the group consisting of mechanical polishing, chemical-mechanical polishing, and electropolishing.

5. The method of claim 4, wherein the polishing step is mechanical polishing.

6. The method of claim 1, wherein the powder particles are from about 1 to about 100 microns in size.

7. The method of claim 1, wherein the powder particles are from about 15 to about 50 microns in size.

8. The method of 1, wherein the applying step comprises combustion flame spraying.

9. The method of claim 1, wherein the powder particles are from about 5 to about 20 microns in size.

10. The method of claim 1, wherein the applying step comprises high velocity oxy fuel spraying.

11. The method of claim 1, wherein the relative coefficient of friction between the non-stick surface and hard steel is from about 0.06 to about 0.4.

12. The method of claim 1, wherein the relative coefficient of friction between the non-stick surface and hard steel is less than about 0.2.

13. The method of claim 1, wherein the relative coefficient of friction between the non-stick surface and hard steel is less than about 0.1.

14. The method of claim 1, wherein the relative coefficient of friction between the non-stick surface and hard steel is less than about 0.08.

15. The method of claim 1, wherein the powder particles are from about 15 to about 50 microns in size; the applying step comprises combustion flame spraying; the polishing step comprises mechanical polishing; and the relative coefficient of friction between the non-stick surface and hard steel is less than about 0.1.

16. The method of claim 1, wherein the powder particles are from about 5 to about 20 microns in size; the applying step comprises high velocity oxy fuel spraying; the polishing step comprises mechanical polishing; and the relative coefficient of friction between the non-stick surface and hard steel is less than about 0.1.

17. The method of claim 1, wherein the nanostructured zirconia powder particles are nanostructured stabilized zirconia powder particles.

18. The method of claim 17, wherein the nanostructured stabilized zirconia powder particles are stabilized with alkali earth compounds, rare earth compounds, or combinations thereof.

19. A non-stick surface on a metal substrate, wherein the non-stick surface comprises at least one of nanostructured zirconia or nanostructured titania, wherein the relative coefficient of friction between the non-stick surface and hard steel is less than about 0.4.

20. The non-stick surface on a metal substrate of claim 19, wherein the non-stick surface comprises nanostructured zirconia and nanostructured titania.

21. The non-stick surface on a metal substrate of claim 19, wherein the non-stick surface comprises least one of nanostructured zirconia powder particles or nanostructured titania powder particles.

22. The non-stick surface on a metal substrate of claim 21, wherein the non-stick surface comprises nanostructured zirconia powder particles and nanostructured titania powder particles.

23. The non-stick surface on a metal substrate of claim 21, wherein the powder particles are from about 1 to about 100 microns in size.

24. The non-stick surface on a metal substrate of claim 21, wherein the powder particles are from about 15 to about 50 microns in size.

25. The non-stick surface on a metal substrate of claim 21, wherein the powder particles are from about 5 to about 20 microns in size.

26. The non-stick surface on a metal substrate of claim 19, wherein the relative coefficient of friction between the non-stick surface and hard steel is from about 0.06 to about 0.4.

27. The non-stick surface on a metal substrate of claim 19, wherein the relative coefficient of friction between the non-stick surface and hard steel is less than about 0.2.

28. The non-stick surface on a metal substrate of claim 19, wherein the relative coefficient of friction between the non-stick surface and hard steel is less than about 0.1.

29. The non-stick surface on a metal substrate of claim 19, wherein the relative coefficient of friction between the non-stick surface and hard steel is less than about 0.08.
